(19) United States
(12) Patent Application Publication
(10) Pub. No.: US 2025/0307960 A1
(43) Pub. Date: Oct. 2, 2025

(54) POKER STUDY DEVICE

(71) Applicant: Christopher Cullen, Chicago, IL (US)

(72) Inventor: Christopher Cullen, Chicago, IL (US)

(21) Appl. No.: 18/622,548

(22) Filed: Mar. 29, 2024

(51) Int. Cl. G06Q 50/10; A63F 1/00

(52) U.S. Cl. CPC G06Q 50/10; A63F 1/00; A63F 2001/005

(57) ABSTRACT

The system includes at least one memory and one or more processors that may be configured to receive an input corresponding to a poker hand of a user. The at least one memory and one or more processors are configured to model a plurality of user actions. Modeling the plurality of user actions may be based on at least two of: the poker hand of the user, a user position in a turn order relative to one or more positions in the turn order corresponding to other players, other player positions in the turn order, an action by another player, and a value attributed to the user. The visual representation includes a first axis including two positions in the turn order, a second axis including a position in the turn order by another player, and at least one indicator including one of the plurality of user actions.

### FIELD

The present invention relates generally to the field of poker. Specifically, the present invention relates to a device for studying game theory optimal (GTO) poker play.

### BACKGROUND

Game Theory Optimal (GTO) poker refers to a strategy in poker that is theoretically unexploitable, meaning it cannot be consistently beaten by any opponent playing a fixed strategy. The concept of GTO is derived from game theory, a branch of mathematics that deals with decision-making in competitive situations. GTO poker strives to achieve a balanced approach to the game, where a player's strategy is constructed in a way that prevents opponents from gaining an advantage by exploiting predictable patterns. A player using GTO concepts will not only play each individual hand well, but will vary their play across hands so as to reduce predictability, making it much more difficult for the player to be exploited by an opponent.

Key principles of GTO poker include range balancing, frequency-based play, game-tree analysis, and positional awareness. Under the range balancing concept, players aim to have a balanced range of hands in every situation. This means having a mix of strong and weak hands that are played in the same way, making it difficult for opponents to determine the strength of their hand based on their actions.

With frequency-based play, GTO players use a specific frequency to play each hand in their range. For example, if a GTO strategy dictates that a player should bluff 33% of the time in a specific situation, they will bluff exactly one-third of the time to maintain balance.

Employing positional awareness, GTO players are mindful of their position at the table and adjust their strategy accordingly. They tend to be more aggressive when acting later in a hand, as they have more information about their opponents' actions and can better gauge the strength of each opponent's hand.

Game tree analysis involves analyzing complex decision trees that arise during different stages of a hand. Players use tools like solvers to calculate optimal frequencies and strategies based on the underlying mathematical principles to select from a range of optimal moves for a given situation.

Poker players may use GTO poker solvers to study GTO poker play. The solvers require detailed and extensive inputs and may only display GTO play for one particular situation. Solvers are primarily used for post-flop GTO play. Preflop charts are difficult for many to study, due to the complexity of preflop play. There is a need in the industry for a more intuitive method of studying optimal pre-flop ranges and play.

### SUMMARY OF THE INVENTION

One embodiment of the invention relates to a system. In some embodiments, the system includes at least one memory and one or more processors. In some embodiments, the at least one memory and one or more processors are configured to receive an input corresponding to a poker hand of a user. In some embodiments, the at least one memory and one or more processors are configured to model a plurality of user actions. In some embodiments, modeling the plurality of user actions is based on at least two of: the poker hand of the user, a user position in a turn order relative to one or more positions in the turn order corresponding to one or more other players, at least one of the one or more other player positions in the turn order, an action by another player, and a value attributed to the user. In some embodiments, the value is relative to a bet size. In some embodiments, the at least one memory and one or more processors are configured to generate and provide a graphical user interface (GUI) including a visual representation. In some embodiments, the visual representation includes a first axis including two positions in the turn order, a second axis including a position in the turn order by another player, and at least one indicator including one of the plurality of user actions.

In some embodiments, the second axis further includes an action by another player. In some embodiments, the action by another player is a bet. In some embodiments, the graphical user interface further includes a grid, including an indicator for a plurality of poker hands and an indicator for the poker hand of the user or for a class of poker hands. In some embodiments, the graphical user interface further includes characteristics of the poker hand, wherein the characteristics include hand nomenclature, whether the hand is suited, and card values. In some embodiments, the plurality of user actions include folding, calling, or raising. In some embodiments, the plurality of user actions are raises. In some embodiments, the raises are a first raise of a preflop betting round, a second raise of the preflop betting round, or a third raise of the preflop betting round. In some embodiments, the poker hand is a starting poker hand.

Other embodiments relate to a method. In some embodiments, the method includes selecting a poker hand of a user or a class of poker hands. In some embodiments, the method includes modeling, by one or more processing circuits, a plurality of user actions. In some embodiments, modeling the plurality of user actions is based on at least two of: the poker hand of the user, a user position in a turn order relative to one or more positions in the turn order corresponding to one or more other players, at least one of the one or more other player positions in the turn order, an action by another player, and a value attributed to the user. In some embodiments, the value is relative to a bet size. In some embodiments, the value is a stack size associated with the user. In some embodiments, the method includes providing a visual representation to the user. In some embodiments, the visual representation includes a first axis including two positions in the turn order, a second axis including a position in the turn order by another player, and at least one indicator including one of the plurality of user actions.

In some embodiments, the second axis further includes an action by another player. In some embodiments, the action by another player is a bet. In some embodiments, the graphical user interface further includes a grid, including an indicator for a plurality of poker hands and an indicator for the poker hand of the user. In some embodiments, the graphical user interface further includes characteristics of the poker hand. In some embodiments, the characteristics include hand nomenclature, whether the hand is suited, and card values. In some embodiments, the plurality of user actions include one or more of folding, calling, or raising. In some embodiments, the plurality of user actions are raises. In some embodiments, the raises are a first raise of a preflop betting round, a second raise of the preflop betting round, or a third raise of the preflop betting round. In some embodiments, the poker hand of the user is a starting poker hand. In some embodiments, providing the visual representation to the user is performed via a graphical user interface or a card.

Other embodiments relate to an apparatus for studying poker. In some embodiments, the apparatus includes at least one learning device including a first display and a second display. In some embodiments, the at least one learning device is configured to selectively present one of the first display or the second display during a user interaction event. In some embodiments, the first display includes at least one graphical representation of a poker hand. In some embodiments, the second display includes at least one graphical representation of a visual representation. In some embodiments the visual representation includes a first axis including two positions in a turn order, a second axis including a position in the turn order by another player, and at least one indicator including one of a plurality of user actions.

In some embodiments, the at least one learning device includes a first learning device and a second learning device. In some embodiments, the first display further includes a grid, including an indicator for a plurality of poker hands and an indicator for the poker hand or for a class of poker hands. In some embodiments, the second display further includes characteristics of the poker hand or class of poker hands. In some embodiments, the characteristics include hand nomenclature, whether the hand is suited, and card values. In some embodiments, the plurality of user actions include folding, calling, and raising. In some embodiments, the plurality of user actions are raises, wherein the raises are a first raise of a preflop betting round, a second raise of the preflop betting round, or a third raise of the preflop betting round.

### BRIEF DESCRIPTION OF THE DRAWINGS

FIG. 1 is a block diagram depicting an example of a system for poker study device operations and a computing environment, according to some arrangements.

FIG. 2 is a block diagram illustrating an example computing system suitable for use in the example embodiments described herein.

FIG. 3 is a flowchart of the method, according to some embodiments.

FIG. 4 is a basic graphical user interface that includes a visual representation, according to some embodiments.

FIG. 5 is graphical user interface that includes multiple visual representations and displays, according to some embodiments.

FIG. 6 is a graphical user interface that includes a simplified visual representation, according to some embodiments.

FIG. 7 is an analog poker study device, according to some embodiments.

### DETAILED DESCRIPTION

Referring generally to the Figures, the systems and methods described herein relate to computing GTO poker play and to displaying GTO options for different poker starting hands. In particular, the systems and methods relate to modeling GTO poker actions for starting hands of Texas Hold 'Em and to displaying GTO poker actions for starting hands of Texas Hold 'Em. The systems and methods may display a set of actions for one hand at a time or may display a set of actions for a class of starting hands. Thus, users can study GTO poker in a digestible fashion, either considering individual hands or classes of hands. Users who are overwhelmed by the intricacies of GTO poker are able to study with a user-friendly device that breaks the information presented down into digestible pieces, allowing a user to develop a more intuitive sense of how to play poker using GTO poker principles.

Generally, GTO poker play involves poker players making decisions that maximize long-term profits. To determine what decisions maximize profits, computers will simulate poker games to determine the result of every possible decision by both the player (hero) and opponents (villains). Based on the results of the simulated games, computers will suggest actions to the player that are the least exploitable by opponents at the poker table. The computers will present action information in preflop charts. Preflop charts show each possible starting hand. Users can input parameters for specific scenarios for a poker game, and the preflop chart will highlight what to do with each starting hand. For example, a user could input that they are in the big blind position and an opponent in the small blind position just raised. The user could also input the amount of money that they have available for betting. This information may be represented relative to the value of the bet required by the big blind. For example, the user may input to the computer that they have a stack size of 100 big blinds. Based on those inputs, the computer will highlight that the user should call the raise with certain hands, re-raise with other hands, and fold with some hands. The computer may also indicate that the user should take one action a certain percentage of instances and another action a certain percentage of instances. Since preflop charts show every hand, they present a large amount of information at once and can be overwhelming. The large amount of information also makes it difficult for users to develop an intuitive sense of GTO poker play.

The present invention breaks down GTO poker play information differently than preflop charts. While preflop charts display GTO actions for all starting hands under a specific set of circumstances, the present invention is capable of displaying GTO actions for individual starting hands under a few different sets of common circumstances. Users can select which hand or class of hands they want to study, and the device will display the hand or class of hands, along with a set of GTO actions corresponding to the user selection. This greatly reduces the amount of information presented to the user at once, making it easier to study and digest. Users can develop an intuitive sense of GTO poker play by reviewing GTO actions in a digestible format.

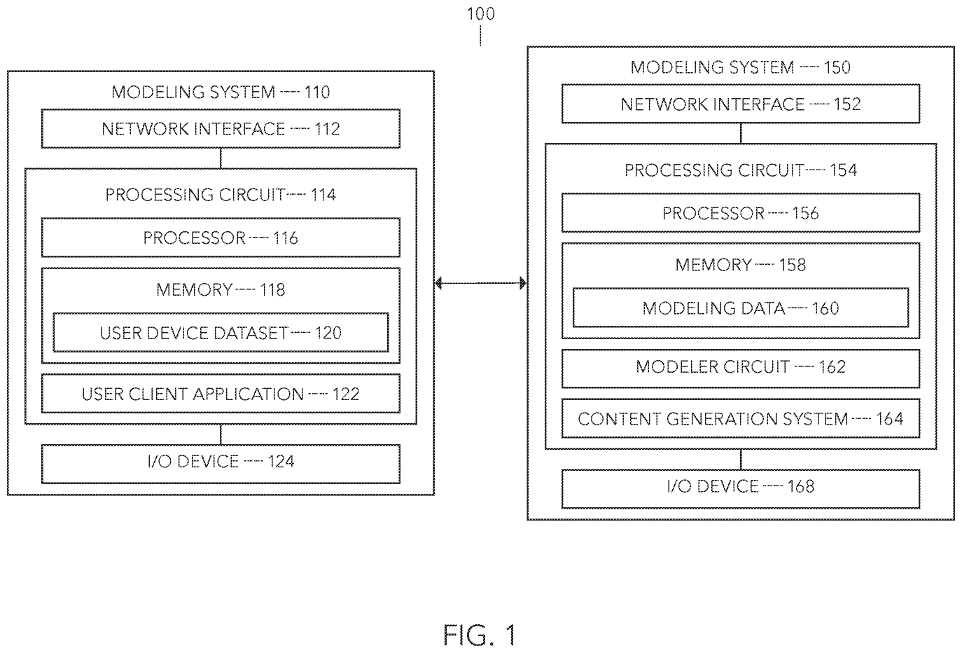

Referring to FIG. 1, a block diagram depicts an example of a poker study device system 100, according to some embodiments. The poker study device system 100 includes a user device 110 and a modeling system 150. In some embodiments, the user device 110 and the modeling system 150 are directly communicably coupled. In some embodiments, the components of the poker study device system 100 may be communicably and operatively coupled to each other over a network that permits the direct or indirect exchange of data, values, instructions, messages, and the like (represented by double-headed arrows in FIG. 1). The network may include one or more of ethernet, an intranet, a cellular network, the Internet, Wi-Fi, Wi-Max, and/or any other kind of wireless or wired network.

Each system or device in the poker study device system 100 may include one or more processors, memories, network interfaces (sometimes referred to herein as a “network circuit”) and user interfaces. The memory may store programming logic that, when executed by the processor, controls the operation of the corresponding computing system or device. The memory may also store data in databases. For example, memory 158 may store programming logic that when executed by processor 156 within processing circuit 154, causes modeling data 160 to model information for GTO poker play with communications received from a user device 110. In some embodiments, the modeling data 160 is calculated by a modeler circuit 162 in response to communications received from a user device 110. However, it is possible to store modeling data for many or all of the potential scenarios that may arise in a game of poker. Thus, in some embodiments, the modeling data 160 is a database stored in a memory 158 that contains data for potential communications from a user device. The database may contain data for all potential scenarios, or it may be a limited dataset. In such embodiments, the modeling data 160 is called from the memory 158 in response to the communications received from a user device 110. In embodiments in which the dataset contains all potential scenarios, the system may not include a modeling circuit 162. In embodiments in which the data is a limited dataset, when presented with communications received from a user device 110 that pertain to a scenario outside of the limited dataset, the modeling data 160 may be calculated by a modeler circuit 162 in response to the communications. The network interfaces (e.g. network interface 112 of user device 110, sometimes referred to herein as a “network circuit”) may allow the computing systems and devices to communicate wirelessly or otherwise. The various components of devices in the poker study device system 100 may be implemented via hardware (e.g. circuitry), software (e.g. executable code), or in any combination thereof. Devices and components in FIG. 1 can be added, deleted, integrated, separated, and/or rearranged in various embodiments of the disclosure.

The modeling system 150 includes a network interface 152, a processing circuit 154, and an input/output device 168. The network interface 152 is structured and used to establish connections with other computing systems and devices (e.g., the user device 110) via a network or a direct connection. The network interface 152 includes program logic that facilitates connection of the modeling system 150 to the user device 110. For example, the network interface 152 may include any combination of a wireless network transceiver (e.g., a cellular modem, a Bluetooth transceiver, a WiFi transceiver, etc.) and/or a wired network transceiver (e.g. an Ethernet transceiver). In some embodiments, the network interface 152 includes the hardware (e.g., processor, memory, and so on) and machine-readable media sufficient to support communication over multiple channels of data communication. Further, in some embodiments, the network interface 152 includes cryptography capabilities to establish a secure or relatively secure communication session in which data communicated over the session is encrypted. In some embodiments, the poker study device system 100 can adapt to network traffic needs by compressing content, by any computing device described herein, and sending it to various other computing devices, by adjusting security filters to remove junk traffic (e.g., by monitoring packets), and so on.

The processing circuit 154 includes a processor 156, a memory 158, a modeler circuit 162, and a content generation system 164. The memory 158 may be one or more devices (e.g., RAM, ROM, Flash memory, hard disk storage) for storing data and/or computer code for completing and/or facilitating the various processes described herein. The memory 158 may be or include non-transient volatile memory, non-volatile memory, and non-transitory computer storage media. Memory 158 may include database components, object code components, script components, or any other type of information structures described herein. Memory 158 may be communicably coupled to the processor 156 and include computer code or instructions for executing one or more processes described herein. The processor 156 may be implemented as one or more application specific integrated circuits (ASICs), field programmable gate arrays (FPGAs), a group of processing components, or other suitable electronic processing components. As such, the modeling system 150 is configured to run a variety of circuits and store associated data in a database of the memory 158 (e.g., modeling data 160). Such circuits may include the modeler circuit 162 and the content generation system 164.

The memory 158 may store modeling data 160, in some embodiments. The modeling data 160 may be configured to store information about poker hands, poker positions, bet sizes, and starting chip stacks. The modeling data may be further configured to store information about GTO play for various poker situations and positions. The modeling data may be configured to store information about GTO play for specific poker hands for varying player positions, player chip stack sizes, opponent positions, and opponent bets.

The processing circuit 154 also is shown to include a modeler circuit 162. The modeler circuit 162 implements data fusion operations of the modeling system 150. In various arrangements, the modeler circuit 162 can be configured to receive a plurality of data (e.g., poker hands, poker positions, bet sizes, and starting chip stacks). In some embodiments, the modeler circuit 162 models poker games based on the plurality of data. In some embodiments, the modeler circuit 162 determines which user actions are GTO actions. In some embodiments, the modeler circuit queries the modeling data 160 for user actions that are GTO actions according to the plurality of data received. In some embodiments, the modeler circuit 162 generates content that presents GTO actions.

The processing circuit 154 also is shown to include a content generation system 164. The content generation system 164 may be configured to generate content for displaying to users. The content can be selected from among various resources (e.g., webpages, applications). The content generation system 164 is also structured to provide content (e.g., via a graphical user interface (GUI)) to the user device 110 for display within the resources. The content from which the content generation system 164 selects may be provided by modeling system 150 to the user device 110. In some embodiments, the content generation system 164 may select content to be displayed on the user device 110. In such implementations, the content generation system 164 may determine content to be generated and published in one or more content interfaces of resources (e.g., webpages, applications).

The content generation system 164 may include one or more systems (e.g., computer-readable instructions executable by a processor) and/or circuits (e.g., ASICs, Processor Memory combinations, logic circuits) configured to perform various functions of the content generation system 164. The content generation system 164 can be run or otherwise be executed on one or more processors of a computing device. In various arrangements, the content generation system 164 includes various transitory and/or non-transitory storage media. The storage media may include magnetic storage, optical storage, flash storage, and RAM. It should be understood that various embodiments may include more, fewer, or different systems relative to those illustrated in FIG. 1, and all such modifications are contemplated within the scope of the present disclosure.

Still referring to FIG. 1, the input/output device 168 is structured to exchange data, communications, instructions, etc. with and input/output component of the modeling system 150. In one embodiment, the input/output device 168 includes communication circuitry for facilitating the exchange of data, values, messages, and the like between the input/output device 168 and the components of the modeling system 150. In one embodiment, the input/output device 150 includes machine-readable media for facilitating the exchange of information between the input/output device 150 and the components of the modeling system 150. In one embodiment, the input/output device 168 includes any combination of hardware components, communication circuitry, and machine-readable media.

In some embodiments, the input/output device 168 includes any suitable input/output ports and/or uses and interconnect bus for interconnection with a local display (e.g., a touchscreen display) and/or keyboard/mouse devices (when applicable), or the like, serving as a local user interface for programming and/or data entry, retrieval, or other user interaction purposes. As such, the input/output device 168 may provide an interface for the user to interact with various applications stored on the modeling system 150. For example, the input/output device includes a keyboard, a keypad, a mouse, joystick, a touch screen, a microphone, a biometric device, a virtual reality headset, smart glasses, smart headsets, and the like. As another example, the input/output device 168 may include, but is not limited to, a television monitor, a computer monitor, a printer, a facsimile, a speaker, and so on.

The poker study device system 100 also includes a user device 110, according to some embodiments. The user device may be a variety of suitable user computing devices. For example, the user devices 110 may include mobile phones. In other embodiments, the user devices 110 include personal computers (e.g., desktop computers or laptop computers), tablets, smart watches or other wearable devices (e.g., rings, jewelry, headsets, bands), smart glasses, headphones, smart vehicle voice/touch command systems, virtual/augmented reality (VR/AR) systems (e.g., smart glasses, smart headsets), appliances, internet of things (IoT) devices, voice assistants, at-home touch screen display systems, and/or any other suitable user computing devices capable of accessing and communicating using local and/or global networks.

The user devices 110 may each similarly include a network interface 112, a processing circuit 114, and an input/output device 124. The network interface 112, the processing circuit 114, and the input/output device 124 may be structured and function substantially similar to and include the same or similar components as the network interface 152, the processing circuit 154, and the input/output device 168 described above, with reference to the modeling system 150. Therefore, it should be understood that the description of the network interface 152, the processing circuit 154, and the input/output device 168 of the modeling system 150 provided above may be similarly applied to the network interface 112, the processing circuit 114, and the input/output device 160 the user device 110.

In some embodiments, the network interface 112 is similarly structured and used to establish connections with other computing systems (e.g., the modeling system 110) via a network or a direct connection. The network interface 112 may further include any or all of the components discussed above, with reference to the network interface 152.

The processing circuit 114 similarly includes a processor 116, a memory 118, and a user client application 122. The memory 118 and the processor 116 are substantially similar to the memory 158 and the processor 156 described above. Accordingly, the user devices 110 are similarly configured to run a variety of application programs and store associated data in a database of the memory 118. For example, the user devices 110 may be configured to run an application such as the user client application 122 that is stored in the user device dataset 120. In another example, the user devices 110 may be configured to store various user data, such as, but not limited to, personal user device information (e.g., names, addresses, phone numbers, contacts, call logs, installed applications, and so on), user device authentication information (e.g., username/password combinations, device authentication tokens, security question answers, unique client identifiers, biometric data (such as digital representations of biometrics), geographic data, social media data, application specific data, and so on), and user history relating what poker hands the user has viewed.

In some embodiments, the user client application 122 may be incorporated with an existing application in use by the user device 110 (e.g., a mobile provider application, a service provider application, etc.). In other embodiments, the user client application 122 is a separate software application implemented on the user device 110. The user client application 122 may be downloaded by the user device 110 prior to its usage, hard coded into the memory 118 of the user device 110, or be a network-based or web-based interface application such that the user device 110 may provide a web browser to access the application, which may be executed remotely from the user device 110. Accordingly, the user device 110 may include software and/or hardware capable of implementing a network-based or web-based application. For example, in some instances, the user client application 122 includes software such as HTML, XML, WML, SGML, PHP (Hypertext Preprocessor), CGI, and like languages.

In the latter instance, a user may log onto or access the web-based interface before usage of the application. In this regard, the user client application 122 may be supported by a separate computing system (e.g., modeling system 150) including one or more servers, processors, network interface (sometimes referred to herein as a “network circuit”), and so on, that transmit applications for use to the user device 110. In some embodiments, the user client application 122 includes an application programming interface (API) and/or a software development kit (SDK) that facilitate the integration of other applications with the user client application 122.

The input/output device 124 of each user device 110 may function substantially similar to and include the same or similar components as the input/output device 168 previously described, with reference to the modeling system 150. As such, it should be understood that the description of the input/output device 168 provided above may also be applied to the input/output device 124 of each of the user device 110. In some embodiments, the input/output device 124 of each user device 110 is similarly structured to receive communications from and provide communications to a user.

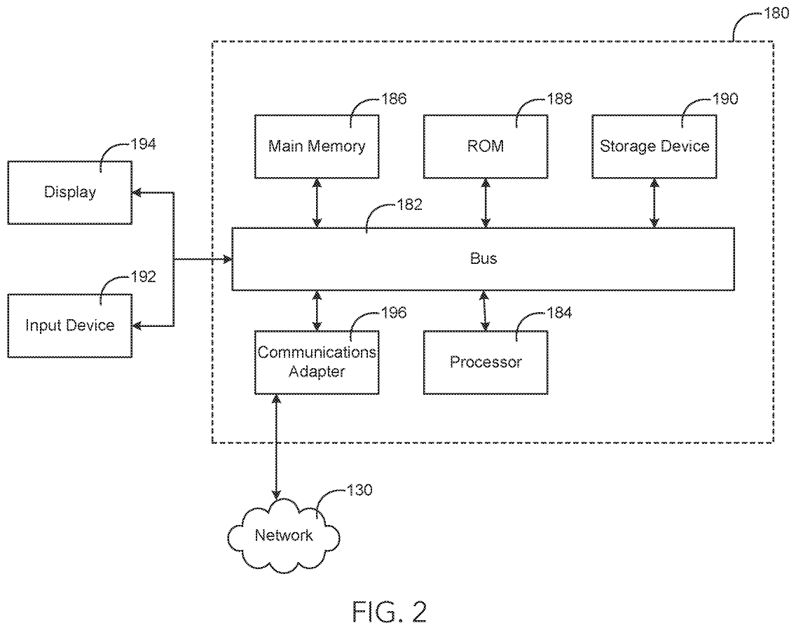

FIG. 2 illustrates a depiction of a computing system 180 that can be used, for example, to implement a modeling system 150, a user device 110, and/or various other example systems described in the present disclosure. The computing system 180 includes a bus 182 or other communication component for communicating information and a processor 184 coupled to the bus 182 for processing information. The computing system 180 also includes main memory 186, such as a random-access memory (RAM) or other dynamic storage device, coupled to the bus 182 for storing information, and instructions to be executed by the processor 184. Main memory 186 can also be used for storing position information, temporary variables, or other intermediate information during execution of instructions by the processor 184. The computing system 180 may further include a read only memory (ROM) 188 or other static storage device coupled to the bus 182 for storing static information and instructions for the processor 184. A storage device 190, such as a solid-state device, magnetic disk or optical disk, is coupled to the bus 182 for persistently storing information and instructions.

The computing system 180 may be coupled via the bus 182 to a display 194, such as a liquid crystal display, or active matrix display, for displaying information to a user. An input device 192, such as a keyboard including alphanumeric and other keys, may be coupled to the bus 182 for communicating information, and command selections to the processor 184. In another arrangement, the input device 192 has a touch screen display 194. The input device 192 can include any type of biometric sensor, a cursor control, such as a mouse, a trackball, or cursor direction keys, for communicating direction information and command selections to the processor 164 and for controlling cursor movement on the display 194.

In some arrangements, the computing system 180 may include a communications adapter 196, such as a networking adapter. Communications adapter 196 may be coupled to bus 182 and may be configured to enable communications with a computing or communications network 130 and/or other computing systems. In various illustrative arrangements, any type of networking configuration may be achieved using communications adapter 196, such as wired (e.g., via Ethernet), wireless (e.g., via Wifi, Bluetooth, and so on), satellite (e.g., via GPS) pre-configured, ad-hoc, LAN, WAN, and so on.

According to various arrangements, the processes that effectuate illustrative arrangements that are described herein can be achieved by the computing system 180 in response to the processor 184 executing an arrangement of instructions contained in main memory 186. Such instructions can be read into main memory 186 from another computer-readable medium, such as the storage device 190. Execution of the arrangement of instructions contained in main memory 166 causes the computing system 180 to perform the illustrative processes described herein. One or more processors in a multi-processing arrangement may also be employed to execute the instructions contained in main memory 186. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 2, arrangements of the subject matter and the functional operations disclosed herein can be carried out using other types of digital electronic circuitry, or in computer software (e.g., application, blockchain, distributed ledger technology) embodied on a tangible medium, firmware, or hardware, including the structures disclosed in this application and their structural equivalents, or in combinations of one or more of them. Arrangements of the subject matter disclosed herein can be implemented as one or more computer programs, e.g., one or more subsystems of computer program instructions, encoded on one or more computer storage medium for execution by, or to control the operation of, a data processing apparatus. Alternatively, or in addition, the program instructions can be encoded on an artificially generated propagated signal, e.g., a machine generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, drives, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 180 may include virtualized systems and/or system resources. For example, in some arrangements, the computing system 180 may be a virtual switch, virtual router, virtual host, virtual server, etc. In various arrangements, computing system 180 may share physical storage, hardware, and other resources with other virtual machines. In some arrangements, virtual resources of the network 130 may include cloud computing resources such that a virtual resource may rely on distributed processing across more than one physical processor, distributed memory, etc.

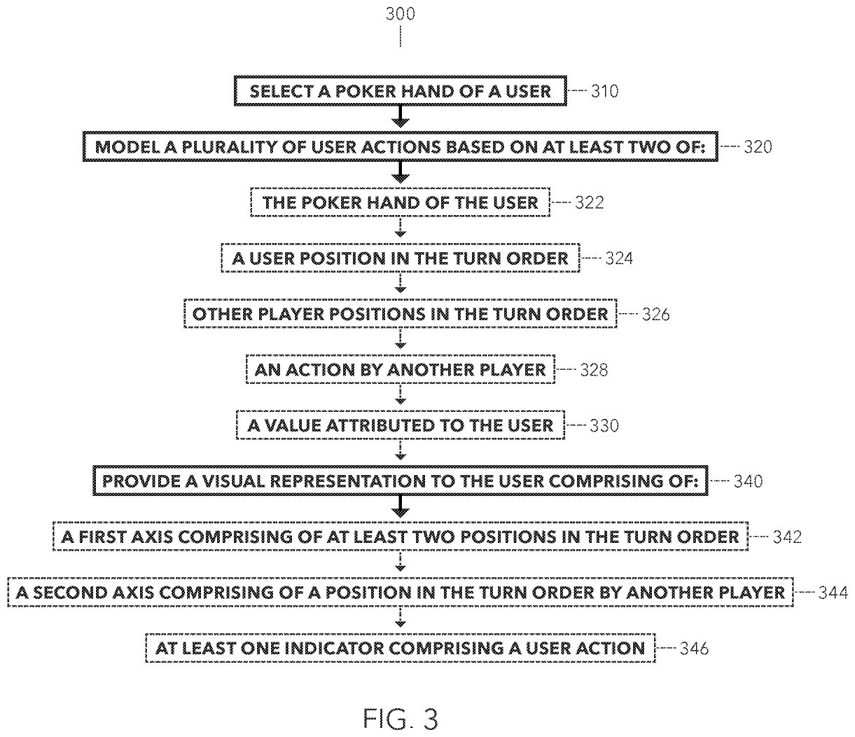

Referring now to FIG. 3, a flow diagram of a method 300 for generating a graphical user interface (GUI) including GTO poker actions is shown, according to some embodiments. The method 300 may be provided by and/or accessible by the user client application 122, for example. The method 300 may be performed by the modeling system 150 or the user device 110, described above pertaining to FIG. 1. In some embodiments, the method 300 begins in response to a user downloading the user client application 122 and logging in with their account information. In some embodiments, the method 300 begins when the user initiates a session. In some embodiments, the method may begin at a specified time. For example, the modeling system 150 may designate intervals when the method will begin. In some embodiments, the method may begin when the user arrives at a specified location.

At 310, the method includes selecting a poker hand of a user. In some embodiments, the poker hand of the user includes playing cards or representations of playing cards. In some embodiments, the playing cards are from a standard deck of playing cards (i.e. 52 cards consisting of four suits each having a King, Queen, Jack, Ten, Nine, Eight, Seven, Six, Five, Four, Three, Two, and Ace cards). In some embodiments, the playing cards are from a customizable deck, in which the user customizes the number of total or individual cards. In some embodiments, the playing cards are from a deck that is randomly generated.

In some embodiments, the poker hand of the user includes either two, four, or five playing cards. In some embodiments, the poker hand of the user is a starting poker hand. In some embodiments, the poker hand of the user is a starting hand in Texas Hold 'Em (i.e. two cards). In some embodiments, the poker hand of the user is a starting hand in Omaha. In some embodiments, the poker hand of the user is a starting hand in Five-Card Draw. Texas Hold 'Em, Omaha, and Five-Card Draw are all poker variants. In some embodiments, the user device 110 is configured to execute step 310. In some embodiments, the modeling system 150 is configured to execute step 310. In some embodiments, the modeling data includes a plurality of dimensions. In some embodiments, the plurality of dimensions includes different poker hands, stack sizes, player (hero) positions, opponent (villain) positions, and bet characteristics. In some embodiments, the bet characteristics include bet sizes and whether the bet is a raise first in, three-bet, four-bet, or all-in bet. In some embodiments, the user device(s) 110 receive the modeling data of the user. In some embodiments, the analysis system 150 receives the modeling data of the user. In some embodiments, the analysis system 150 receives the modeling data of the user from the user device 110. In some embodiments, the user device 150 receives the modeling data from the analysis system 150. In some embodiments, a network receives the modeling data of the user. In some embodiments, the modeling system 150 and/or the user device(s) 110 receive the modeling data of the user from a network.

In some embodiments, the network interface 152 of the modeling system 150 receives the modeling data. In some embodiments, the processing circuit 154 of the modeling system 150 receives the modeling data from the network interface 152 of the modeling system 150. In some embodiments, the processing circuit 154 receives the modeling data directly from a network. In some embodiments, the processing circuit 114 of the user device 110 receives the modeling data from the network interface 112 of the user device 110. In some embodiments, the processing circuit 114 receives the modeling data directly from the network. In some embodiments, the processing circuit 114 receives the modeling data directly from the user device 110.

At 320, the method includes modeling a plurality of user actions based on at least two of: the poker hand of the user 322, a user position in the turn order 324, other player positions in the turn order 326, an action by another player 328, and a value attributed to the user 330. In some embodiments, the value attributed to the user is a relative bet size. In some embodiments, the value associated with the user 330 is a stack size associated with the user (e.g., the number of big blind bets that the user could fund with their stack). In some embodiments, the user device 110 is configured to execute step 320. In some embodiments, the modeling system 150 is configured to execute step 320. In some embodiments, the modeler circuit 162 is configured to execute step 320. In some embodiments, modeling a plurality of user actions includes simulating poker games. In some embodiments, simulating poker games includes running the simulations with at least two of the following values held constant: the poker hand of the user 322, a user position in the turn order 324, other player positions in the turn order 326, an action by another player 328, and a value attributed to the user 330. In some embodiments, the poker hand of the user is a poker hand as discussed in paragraph 42. In some embodiments, the user position in the turn order 324 is a position as discussed in paragraph 47. In some embodiments, other player positions in the turn order 326 are positions in the turn order by another player as discussed in paragraph 48. In some embodiments, the action by another player 328 is discussed in paragraph 55. In some embodiments, the value attributed to the user 330 is the amount of poker chips the user has in the poker game. In some embodiments, the value attributed to the user 330 is the relative bet size of the player. In some embodiments, the value attributed to the user 330 is the stack size of the player. In some embodiments, the player is the hero. In poker terminology, the hero is the first-person perspective of a scenario that occurs in a poker game. For example, the user of the cards would be the “hero” who held the poker hand displayed on the poker study device.

In some embodiments, the modeling system 150 models the modeling data to generate GTO actions. In some embodiments, the processing circuit 154 models the modeling data to generate GTO actions. In some embodiments, the modeler circuit 162 models the modeling data and generates GTO actions. In some embodiments, the modeler circuit 162 models the modeling data and the content generation system 164 generates GTO actions. In some embodiments, the user device models the modeling data to generate GTO actions. In some embodiments, the processing circuit 144 models the modeling data to generate the performance indicator. In some embodiments, the user client application 154 models the modeling data to generate the performance indicator.

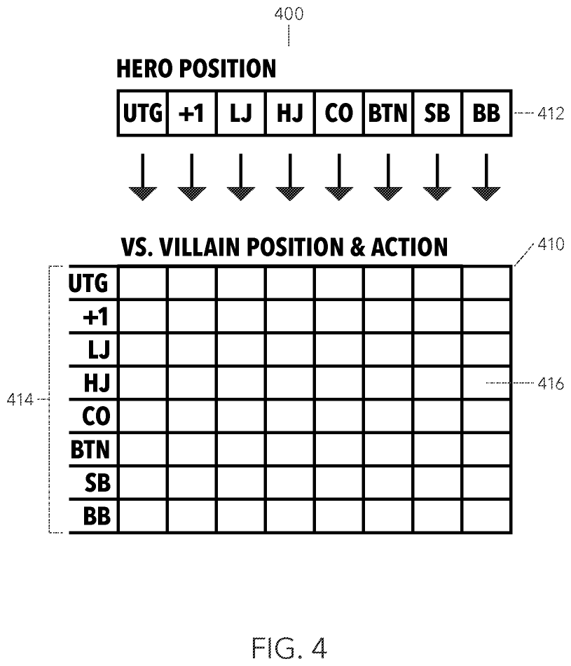

At 340, the method includes providing a visual representation to the user including a first axis including two positions in the turn order 342, a second axis including a position in the turn order by another player 344, and at least one indicator including a user action 346. In some embodiments, the user device 110 is configured to execute step 340. In some embodiments, the modeling system 150 is configured to execute step 340. In some embodiments, the user client application 122 is configured to execute step 340. In some embodiments, the processing circuit 114 of the user device 110 generates and provides the GUI. In some embodiments, the user client application 122 generates and provides the GUI. In some embodiments, the processing circuit 154 of the modeling system 150 generates and provides the GUI. In some embodiments, the content generation system 164 generates and provides the GUI. In some embodiments, the GUI is displayed on the input/output device 124 of the user device 110. In some embodiments, the GUI is displayed on the input/output device 168 of the modeling system 150. More details on embodiments of the visual representation including the first axis 342, second axis 344, and indicator 346 are disclosed in the following discussion of FIGS. 4-6.

FIG. 4 illustrates a graphical user interface 400, according to some embodiments. In some embodiments, the graphical user interface provides a visual representation of data provided by the modeling system 150. In other embodiments, the graphical user interface provides data stored on a memory of a device. In other embodiments. The graphical user interface includes at least one visual representation 410, described more fully below.

In some embodiments, the visual representation 410 is a table. In some embodiments, the visual representation 410 is a chart, graph, or other visual media. The visual representation includes a first axis 412 that includes at least two positions in the turn order. In some embodiments, the at least two positions in the turn order are different positions at a poker table. In some embodiments, the at least two positions are two of: under the gun, under the gun plus one, under the gun plus two, lojack, hijack, middle position, cut off, button, small blind, and big blind. In some embodiments, the under the gun position takes the first turn in the preflop betting order. In some embodiments, the under the gun plus one position takes the second turn in the preflop betting order, the under the gun plus two position takes the third turn, lojack takes the fourth turn, hijack takes the fifth turn, cut off takes the sixth turn, button takes the seventh turn, the small blind takes the eighth turn, and the big blind takes the ninth turn. It should be understood that any number of positions may be displayed on the first axis 412. In some embodiments, the first axis 412 includes two positions in the turn order. In some embodiments, the first axis 412 includes three positions in the turn order. In some embodiments, the first axis 412 includes four positions in the turn order. In some embodiments, the first axis 412 includes five positions in the turn order. In some embodiments, the first axis 412 includes six positions in the turn order. In some embodiments, the first axis 412 includes eight positions in the turn order. In some embodiments, the first axis 412 includes nine positions in the turn order.

The visual representation 410 includes a second axis 414 that includes at least one position in the turn order by another player. In some embodiments, the other player is an opponent. In some embodiments, the opponent is a villain. In poker terminology, the villain is a person whom the “hero” is playing against in a poker game. For example, the hypothetical other person who raises against the person who is using the poker study device is the villain. The positions in the turn order by other players are the same as the positions listed above: under the gun, under the gun plus one, under the gun plus two, lojack, hijack, cut off, button, small blind, and big blind.

The visual representation 410 includes at least one indicator 416 including one of a plurality of user actions. In some embodiments, the plurality of user actions include folding, calling, or raising. In some embodiments, raising includes a minimum raise or placing an all-in bet. In some embodiments, the indicator 416 is an icon. In some embodiments, the indicator 416 uses a color scheme to designate the user action. For example, the indicator 416 could be red for the fold action, blue for the call action, and green for the raise action. In some embodiments, the indicator 416 includes more than one user action. In GTO poker, the best play often involves taking one action a percentage of the time and another action another percentage of the time. In some embodiments, the indicator 416 is partially one color and partially another color, each color corresponding to a user action and the amount of each color proportional to the percentage of the time the user should take the action. For example, if a user should call fifty percent of the time and fold fifty percent of the time, the indicator 416 could be half red and half blue. In some embodiments, the indicator 416 is a solid color bar. In some embodiments, the indicator 416 is an icon that uses visual demonstrations of the action. In some embodiments, the indicator 416 is a word corresponding to the action.

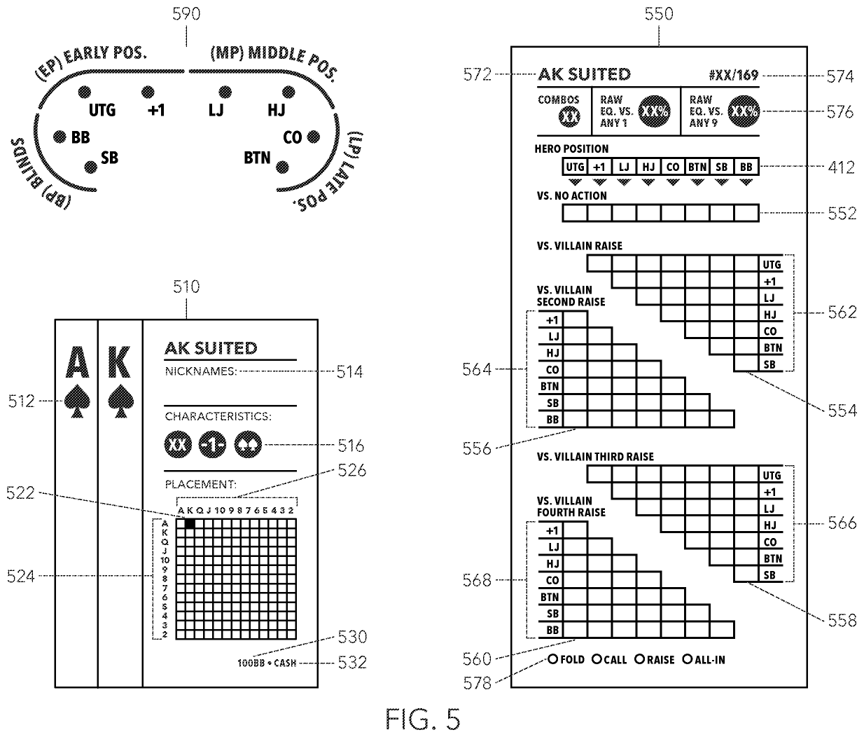

Referring to FIG. 5, the graphical user interface 500 includes a first display 510 and a second display 550, according to some embodiments. In some embodiments, the graphical user interface 500 further includes an illustration of a poker table 590. In some embodiments, the illustration of the poker table 590 includes player positions and labeled categories of the player positions.

The graphical user interface 500 includes a display 510, according to some embodiments. In some embodiments, the display 510 includes an indicator of the poker hand 512. In some embodiments, the indicator of the poker hand 512 indicates a class of poker hands. In some embodiments, the indicator of the poker hand 512 includes the values of the cards and indicates whether the hand is suited. In some embodiments, the indicator of the poker hand 512 includes the card vales and hand suit(s). In some embodiments, the display 510 includes a grid 520 with a location on the grid for a hand combination 522. In some embodiments, the columns and rows of the grid 520 correspond to a card value. For example, in FIG. 3, the row 524 corresponds to the ace card and the column 526 corresponds to the king card. Therefore, in FIG. 3, the location on the grid 522 corresponds to an “ace-king” hand. In some embodiments, the display 510 includes a nickname for the hand 516. In some embodiments, the display 510 includes icons 516 that designate characteristics of the hand, including the value of the highest-ranked card, whether both cards are high in rank, or other important hand characteristics. In some embodiments, the display 510 includes a starting stack size of the player 530. In some embodiments, the display 510 includes an indicator 532 that states whether the GUI includes GTO actions for a cash game or a poker tournament.

The second display 550 includes the visual representations 552, 554, 556, 558, and 560. In some embodiments, the visual representation 552 corresponds to indicating GTO actions when there is no action taken by an opponent. In some embodiments, the visual representation 554 corresponds to indicating GTO actions when an opponent makes a first raise (raise first in). In some embodiments, the visual representation 556 corresponds to when the opponent makes a second raise (three-bet). In some embodiments, the visual representation 558 corresponds to when the opponent makes a third raise (four-bet). In some embodiments, the visual representation 560 corresponds to when the opponent makes a fourth raise (five-bet). The second raise is called a three bet because the first bet is the big blind, and betting the big blind is not a raise, it is a call. The first raise (raise first in) is the second bet.

In some embodiments, the visual representation 554 includes an axis 562. In some embodiments, the axis 562 includes opponent positions in the turn order. In some embodiments, the visual representation includes an axis 564. In some embodiments, the axis 564 also includes opponent positions in the turn order. In some embodiments, visual representation 558 includes an axis 566. In some embodiments, the axis 556 also includes opponent positions in the turn order. In some embodiments, the visual representation 560 includes an axis 568. In some embodiments, the axis 568 also includes opponent positions in the turn order.

In some embodiments, the display 550 includes a color key 578 for the user action. In some embodiments, the color key states 578 which user action corresponds to which color. In some embodiments, the display 550 includes a visual indicator of the poker hand 572. In some embodiments, the display 550 includes a ranking of the hand 574. In some embodiments, the display 550 includes at least one raw equity value of the hand 576.

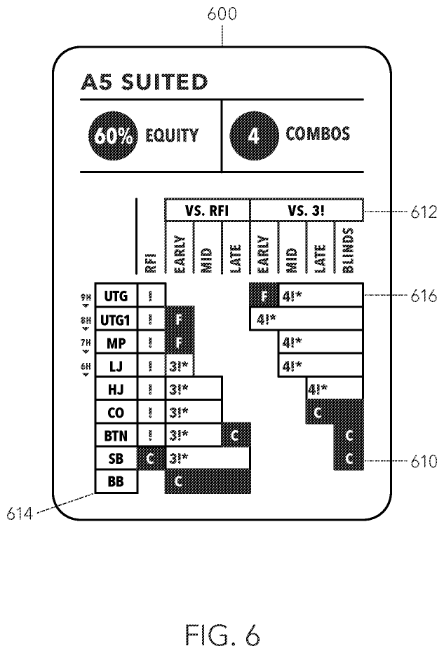

In FIG. 6, a graphical user interface 600 includes a visual representation 610, according to some embodiments. The visual representation 610 includes an axis 612 that includes an action by another player. In some embodiments, the action by another player is a raise. In some embodiments, the action by another player is a raise first in, a three-bet, a four-bet, a five-bet, or an all-in bet. In some embodiments, a raise first in includes raising to a value higher than the big blind. In some embodiments, a three-bet is a raise that occurs after the raise first in. In some embodiments, the four-bet is a raise that follows the three-bet and the five-bet is a raise that follows the four-bet. In some embodiments, the all-in bet is when a poker player bets all their chips. Any bet may be an all-in bet, depending on the bet size and a player's starting stack size. In some embodiments, the first-bet, the second bet, the third-bet, the fourth-bet, or the five-bet is the same as the all-in bet.

In some embodiments, the axis 612 further includes positions for another player for each action by another player. In some embodiments, the positions are early, middle, late, and blind positions. In some embodiments, the early positions include the under the gun and the under the gun plus one positions. In some embodiments, the middle positions include the hijack and lojack positions. In some embodiments, the late positions include the cutoff and button positions. In some embodiments, the visual representation 610 further includes an action indicator 616. In some embodiments, the action indicator 616 indicates that the player should fold, call, or raise. In some embodiments, the action indicator indicates a GTO action. In some embodiments, the action indicator 616 spans multiple points on the visual indicator 610.

The various graphical user interfaces disclosed above can be presented on either a mobile device or a computer display, according to some embodiments. In some embodiments, the graphical user interfaces disclosed above are displayed by an application on a mobile phone that is downloadable from another application like the Apple® App Store or Google® Play Store. In some embodiments, users can access the graphical user interfaces on a web browser through a website. In some embodiments, the user can access the application on a device and select a poker hand. In some embodiments, one of the graphical user interfaces disclosed above will be shown on the device after the user selects the poker hand. In some embodiments, the user can initiate a study session where the application will show different graphical user interfaces corresponding to respective starting poker hands to help the user memorize GTO actions. In some embodiments, the application will prompt the user to answer questions about correct GTO actions for different poker hands and other circumstances. In some embodiments, the application will provide an examination to grade the user on their knowledge of different starting poker hands. In some embodiments, the examination can be narrowed exclusively include certain parameters. For example, the examination could exclusively test the user on GTO actions for hands with an ace card. In other embodiments, the examination could exclusively test the user on GTO actions against an opponent three-betting in the big blind position.

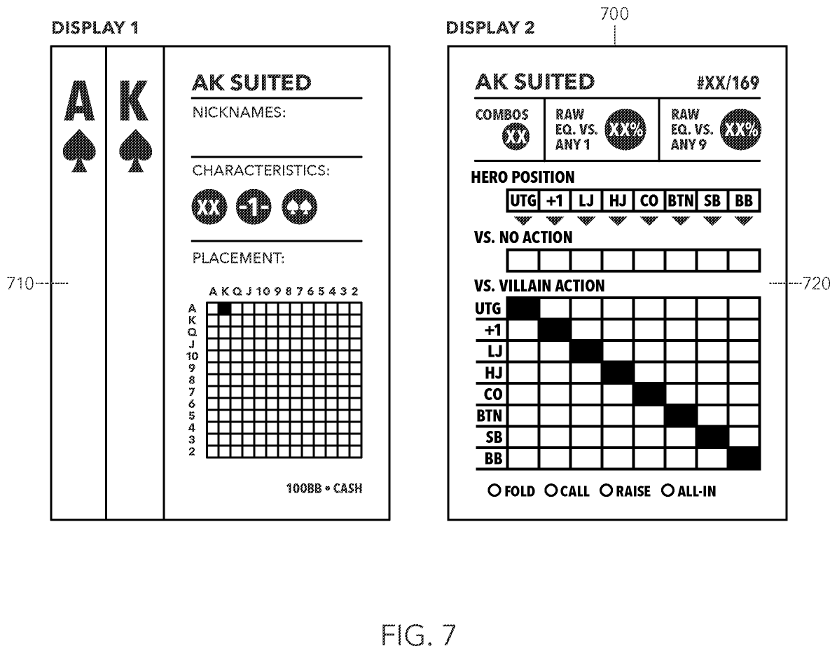

In FIG. 7, the displays disclosed above can alternatively be presented on a study device 700, according to some embodiments. In some embodiments, the study device 700 is an analog device, such as a book, a page, or a flash card. In some embodiments, the study device 700 is a device that includes a first display 710 and a second display 720. In some embodiments, the first display 710 is substantially similar to the graphical user interface 400 shown in FIG. 4. In other embodiments, the first display 710 is substantially similar to either the display 550 shown in FIG. 5 or the graphical user interface 600 shown in FIG. 6. In some embodiments, the second display 720 is substantially similar to the display 510 shown in FIG. 5. In some embodiments, the first display 710 is located on a first side of the study device 700. In some embodiments, the second display 720 is located on a second side of the study device 700. In some embodiments, the study device 700 is configured to lay flat, to be held, or to be positioned upright.

In some embodiments, study device may be configured to include additional displays. This may be carried out through by having multiple displays on a side 710 720 of the study device 700, or by having the study device be foldable so as to display specific information in a given conformation. For example, in some embodiments, the study device 700 may include a foldable side that may be tucked between the first and second side when not in use. The foldable side may include a third display. Similarly, a fourth side may be foldable between the first and second sides and may include a fourth display. The third and fourth displays may be similar to those shown in FIGS. 4-6.

The embodiments described above can allow poker players to develop an intuitive sense of GTO actions at the poker table, according to some embodiments. The graphical user interfaces and study devices can facilitate memorization of GTO actions for common circumstances. Players can memorize optimal poker actions by memorizing the information displayed on the graphical user interfaces and study devices. Additionally, players can develop an intuition for GTO play by reviewing the graphical user interfaces and study devices. For example, if a player remembers that the graphical user interfaces and study devices usually indicate that players should raise most of the time when they have a hand with an ace on the button, then they can raise each time they are on the button with an ace hand. Rote memorization is not necessary when using the graphical user interfaces and study devices. Players can develop a strong intuition for GTO play by recognizing patterns they see when studying the graphical user interfaces and study devices.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A system, comprising:
at least one memory and one or more processors configured to:
receive an input corresponding to a poker hand of a user;
model a plurality of user actions, wherein modeling the plurality of user actions is based on at least two of: the poker hand of the user, a user position in a turn order relative to one or more positions in the turn order corresponding to one or more other players, at least one of the one or more other player positions in the turn order, an action by another player, and a value attributed to the user, wherein the value is relative to a bet size; and
generate and provide a graphical user interface (GUI) comprising a visual representation, wherein the visual representation comprises:
a first axis comprising two positions in the turn order;
a second axis comprising a position in the turn order by another player; and
at least one indicator comprising one of the plurality of user actions.

2. The system of claim 1, wherein the second axis further comprises an action by another player, wherein the action by another player is a bet.

3. The system of claim 1, wherein the graphical user interface further comprises a grid, comprising an indicator for a plurality of poker hands and an indicator for the poker hand of the user or for a class of poker hands.

4. The system of claim 1, wherein the graphical user interface further comprises characteristics of the poker hand, further wherein the characteristics are selected from the group consisting of hand nomenclature, hand suit or suits, and card values.

5. The system of claim 1, wherein the plurality of user actions comprise folding, calling, or raising.

6. The system of claim 1, wherein the plurality of user actions are raises and further wherein the raises are selected from the group consisting of a first raise of a preflop betting round, a second raise of the preflop betting round, and a third raise of the preflop betting round.

7. The system of claim 1, wherein the poker hand is a starting poker hand.

8. A method, comprising:
selecting a poker hand of a user;
modeling, by one or more processing circuits, a plurality of user actions, wherein modeling the plurality of user actions is based on at least two of: the poker hand of the user, a user position in a turn order relative to one or more positions in the turn order corresponding to one or more other players, at least one of the one or more other player positions in the turn order, an action by another player, and a value attributed to the user, wherein the value is relative to a bet size; and
providing a visual representation to the user, wherein the visual representation comprises:
a first axis comprising two positions in the turn order;
a second axis comprising a position in the turn order by another player; and
at least one indicator comprising one of the plurality of user actions.

9. The method of claim 8, wherein the second axis further comprises an action by another player and further wherein the action by another player is a bet.

10. The method of claim 8, wherein the graphical user interface further comprises a grid comprising an indicator for a plurality of poker hands and an indicator for the poker hand of the user or for a class of poker hands.

11. The method of claim 8, wherein the graphical user interface further comprises characteristics of the poker hand, wherein the characteristics are selected from the group consisting of hand nomenclature, hand suit or suits, and card values.

12. The method of claim 8, wherein the plurality of user actions comprise one or more of folding, calling, or raising.

13. The method of claim 8, wherein the plurality of user actions are raises, wherein the raises selected from the group consisting of a first raise of a preflop betting round, a second raise of the preflop betting round, and a third raise of the preflop betting round.

14. The method of claim 8, wherein the poker hand of the user is a starting poker hand.

15. The method of claim 8, wherein providing the visual representation to the user is performed via a graphical user interface or a card.

16. An apparatus for studying poker comprising:
at least one learning device including a first display and a second display;
the at least one learning device being configured to selectively present one of the first display or the second display during a user interaction event;
the first display comprising at least one graphical representation of a poker hand; and
the second display comprising at least one graphical representation of a visual representation, wherein the visual representation comprises:
a first axis comprising two positions in a turn order;
a second axis comprising a position in the turn order by another player; and
at least one indicator comprising one of a plurality of user actions.

17. The apparatus of claim 16, wherein the at least one learning device comprises a first learning device and a second learning device.

18. The apparatus of claim 16, wherein the first display further comprises a grid, comprising an indicator for a plurality of poker hands and an indicator for the poker hand or for a class of poker hands.

19. The apparatus of claim 16, wherein the second display further comprises characteristics of the poker hand, wherein the characteristics are selected from the group consisting of hand nomenclature, hand suit or suits, and card values.

20. The apparatus of claim 16, wherein the plurality of user actions are raises, wherein the raises are selected from the group consisting of a first raise of a preflop betting round, a second raise of the preflop betting round, and a third raise of the preflop betting round.
